(19) United States
(12) Patent Application Publication
(10) Pub. No.: US 2013/0311688 A1
(43) Pub. Date: Nov. 21, 2013

(54) PORTABLE PERSONAL DATA INTERCHANGE DEVICE

(71) Applicant: Adam Jacob Kittinger, Albany, NY (US)

(72) Inventor: Adam Jacob Kittinger, Albany, NY (US)

(21) Appl. No.: 13/472,749

(22) Filed: May 16, 2012

(51) Int. Cl. G06F 13/12

(52) U.S. Cl. 710/63

(57) ABSTRACT

The personal data interchange (PDI) device of this invention is based upon a USB flash memory card interface and a simple direct connection operating feature for information transfer. This device may have the physical appearance of a 1-inch plastic cube or another geometric fob design to be attached to a person's key chain, purse, etc. The device may be configured to accept its owner's personal information in a standard electronic business card (vCard) format. The business version of the device has both a USB plug and USB receptacle. The male version of the device has a USB plug and the female version of the device has a USB receptacle plus a USB adapter. When a USB plug or USB receptacle is properly interfaced to an appropriate gender connector on a companion device, PC, PDA, or a smart phone, a person's information would be automatically transferred to the said devices.

### BACKGROUND OF THE INVENTION

1. Field of the Invention

The present invention relates to a personal data interchange (PDI) device, and more particularly to a small and easy to carry personal data interchange (PDI) device.

2. Description of Related Art

In today's society, people frequently interchange personal or business information almost on a daily basis when they meet in social or business occasions. Such personal data interchanges (PDI) often involve the exchange of names, telephone numbers, addresses, and even business cards, etc. Augmenting PDI by electronics and telecommunications can help ensure that information is quickly and accurately communicated, stored, organized, and easily retrieved when needed for both personal and business networks.

Personal information by nature can be diverse and complex. Yet, diverse and complex information can still be organized into a standard format, allowing for its exchange across many communication channels, be it face-to-face, telephones, e-mail, voice-mail, etc. With the development of the “vCard” as an open industry architecture, there is now a single way to incorporate conventional text information as well as graphics and audio into an information format which is defined by accepted international and industry standards. Indeed, it has found part of its best acceptance in Pal Pilot personal digital assistants, which come with an infrared data (IrDa) port for wireless “vCard” exchange.

Even with personal digital assistant (PDA), smart cell phones, and portable laptop computers invading our social mainstream, there are plenty of consumers who are not digitally connected as a matter of choice. Other times, persons may be out in public but not want to be burdened with having to carry a PDA, smart phone, laptop, etc. Although there are methods or devices disclosed in patents that relate to electronic business card device for transferring business card information from a first user to a second user, most of these devices need display screens, or buttons for the user to make entries or selection in order to accomplish personal data interchange; thus, these devices are also complex, bulkier, or expensive and may not satisfy consumers and business people who just want something simple, small, and affordable.

Therefore, there still exists a need for many consumers and business people who could make use of a dedicated PDI product, provided it is small, easy to carry on one person without losing it, and affordable. That is where the concept of the device of the present invention comes in.

### SUMMARY OF THE INVENTION

One object of the present invention is to provide a PDI device that is simple, small and easy to carry so that people can carry it around in pockets, with key chains, in the purses.

Another object of the present invention is to provide a PDI device that is cost efficient and affordable.

A further object of the present invention is to provide a PDI device that is configured to accept personal information in a standard electronic business card (vCard) format.

Yet another object of the present invention is to provide a PDI device that does not need display screens, icons or buttons for the owner to enter data or push in order to transfer owner's personal information. The device of the present invention when properly interfaced to an appropriate connector on a companion device, the owner's personal information would be automatically transferred to the companion unit.

In an exemplary embodiment of the present invention, there is disclosed a PDI device according to the present invention, which is based upon a USB (Universal Serial Bus) flash memory card interface and a simple direct connection operating feature or wireless feature for information transfer. It may have the physical appearance of a plastic cube of about one inch for each dimension in one embodiment or geometric fob design in another embodiment. In general, the device is small and compact such that it can be a key chain, a purse fob or attached to a person's key chain, purse, etc.

The device of the present invention may have a business version and a social version. The social version can be further categorized into a female version and a male version.

The device of the business version may have a retractable USB port connector (i.e. a USB plug) for data exchanges via a personal computer (PC), personal digital assistant (PDA), smart phone, etc. on one side of the plastic cube as well as a USB port (i.e. a USB receptacle) on any one of the remaining sides. As to the social version of the device, the male version has only a retractable USB plug on one side of the device; and the female version has only a USB receptacle on one side of the device. When either of the connectors (i.e. a USB plug and/or a USB receptacle) is properly interfaced to an appropriate gender connector on a companion device, PC, PDA, or a smart phone, a person's information would be automatically transferred to said devices. Alternatively, the data exchange port may be an infrared port or a radio frequency (RF) antenna for wireless data exchange on any remaining sides of the device. The device comprises an internal data controller and data transceiver circuitry for data transfer purposes. The data controller and transceiver circuitry are coupled to an internal memory partition feature to allow the owner to store personal contact data, business contact data, and other data in separate memory storage locations.

As known in the art, the data content stored in the flash-memory storage products is non-volatile, the data content stored in the device of the present invention would be non-volatile, i.e., would not require a battery backup for data preservation or an outside/third party provider and require logging into their website with a subscription or any “fees” to utilize it. The device further comprises an internal rechargeable battery which is only used to power the internal data controller and data transceiver circuitry for data transfer purposes. Since a typical data transfer would only take a few seconds, a single battery charge should be enough to operate the device for several months of usage, based on its intermittent and short-term nature of power consumption during data exchanges. The device also has automatic power-on/power-off features which would eliminate the need for manual power control buttons and prevent dead-battery situations with the device. The rechargeable battery can be recharged by the power supply of the computer via the USB plug when the device is connected to a computer. The method of or arrangement of wiring or connecting the above electronic components will be well known to those with ordinary skill in the art.

The USB interface could be used for initially transferring the owner's personal information from a PC or PDA into the device. It may also be used for an information exchange to another person's PDA, PC, or smart phone when the individual does not have a companion device for personal data exchange purposes. The device of the present invention may be configured to accept its owner's personal information in a standard electronic business card (vCard) format. It may also be configured to accept image or video files, audio files, text or data files, etc. Security and firewall protection would be included to prevent data virus infection or unintentional data access. The “female version” of the device would be supplied with a “USB adapter” so it may be directly plugged into a personal PC for charging or information downloading. The male version may also have a USB adaptor with a USB receptacle to receive the male end.

The device of the present invention is suggested as a simple PDI solution for many consumers and business people that could be carried as easily and securely as a key chain or purse fob. It is more than a fob-sized USB thumb drive, as it has the capability to not only receive and store information but also send information as well when connected to another device of the present invention or USB compatible digital device. It has security and firewall features like some thumb drives that offer data security options. Unlike the thumb drives, the device of the present invention not only serves as a portable digital storage solution, the device has its own active circuitry to provide simple, timely, and secure data interchange functions.

Furthermore, the device of the present invention has its memory partitioned into separate sections for personal and business data interchange purposes in addition to a general purpose storage solution like other fob-sized USB thumb drives. Alternatively, an individual could carry two devices and have them color-coded or otherwise identified for personal versus business PDI applications.

Each device could come with its own generic vCard format file stored in a separate “send” partition of the device's memory. After the purchase of this device, a person could insert its hinged USB connector into a suitable USB-enable device (computer, PDA, smart phone, etc.) and use that device's keypad or keyboard to create a personalized vCard from that generic vCard format file. Even people who do not own a personal computer, PDA, or smart phone could still use the device, as they could visit a local library or Internet café for computer access or ask a friend with such digital information equipment to help them create their personalized vCard. Once completed, that personalized vCard could be sent hundreds or thousands of times to other device of the present invention as well as any USB-enable digital information device. The vCard transfer could also be automated so that merely connecting to another device of the present invention as a basic personal data interchange tool.

The device of the present invention is portable as it can be a key chain or purse fob item or attached to a key chain, and its small size would allow it to be easily carried on a person even when items like a cell phone or a PDA may not be practical or desirable to carry. It is more durable than a cell phone or PDA, and it may even be constructed so as to be highly water resistant. Whenever a situation arises where a person needs to “travel as light as possible” but still have some form of PDI capability, the device could be a very convenient solution.

This kind of “light PDI capability” may also be appreciated by consumers who grow tired of always being wirelessly connected by one means or another. At the end of a long day, a person may not want to answer another cell phone call or respond to another text message or e-mail. But if single, such a person may still want some PDI capability should he or she meet that special someone in a social setting. With the device, individuals would still have a lightweight and non-intrusive PDI alternative—while still being able to walk away from their cell phones or PDAs for a few hours of quality personal time.

The device of the present invention fulfills the need for a simple personal data exchange device for individuals active in today's digital world.

The appealing features of the device would be its small and simple design, as it may be carried like a key chain or purse fob but would be ready for use at a moment's notice for the timely exchange of digital personal or business information. It may also serve as a standard thumb drive for general file transfers with data-to-go convenience. In addition, individuals would have the option of not only “off the shelf” models of device; but could also custom order their device with additional features such as shapes, colors, lights and sounds. The device may even have both male and female ports on the device to allow data transfer in any situation.

The device may be manufactured using existing technology and make use of relatively standard materials and manufacturing processes. The ultimate design developed may require some variations in current production procedure but would likely not require any new technology.

As a general approach to production, the device could be produced using surface-mount printed circuit card assembly techniques with automated soldering lines and pick and place component handling equipment. Unit enclosures could be injection or structural-foam molded from polystyrene or polycarbonate.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a perspective view of the business version of the device according to one embodiment of the invention.

FIG. 2 is a perspective view of the male version of the device according to one embodiment of the present invention.

FIG. 3 shows a perspective view of the female version of the device as well as a dummy USB adapter according to one embodiment of the present invention.

FIG. 4 shows a perspective view of another embodiment that has infrared port or radio frequency port for wireless data transfer.

FIG. 5 is a block diagram of the internal components according to one embodiment of the device.

### DESCRIPTION OF THE PREFERRED EMBODIMENT

The device of the present invention is a personal information interchange (PDI) device based upon a USB flash memory card interface and a simple direct connection or wireless operating feature for information transfer. The device comprises a controller, transceiver circuitry, and USB connector(s) inside and/or on an enclosure. The device of the present invention may have different shapes; it may be in a rectangular shape with dimensions similar to a flash drive and/or in a shape of a cube about one inch for each dimension. The device is small and compact such that it can be a key chain or a purse fob or attached to a person's key chain, purse, etc. The device has two versions, one is a business version and the other is a social version.

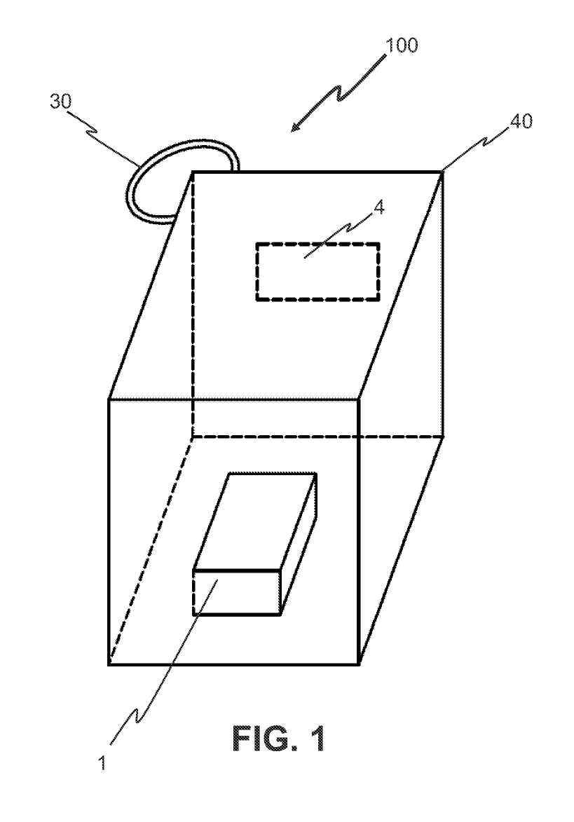

The business version as shown in FIG. 1 has a retractable USB port connector (i.e. a USB plug) 1 for battery charging or information downloading from a PC, or data exchanges (via a companion device 100, a PC, PGA, smart phone, etc) on one side of the cube as well as a USB receptacle 4 on any remaining side of the cube, preferably the directly opposing side of the cube as shown in FIG. 1. When properly interfaced to an appropriate connector on a companion device 100, PC, smart phone, or PDA, a person's information would be automatically transferred to said devices.

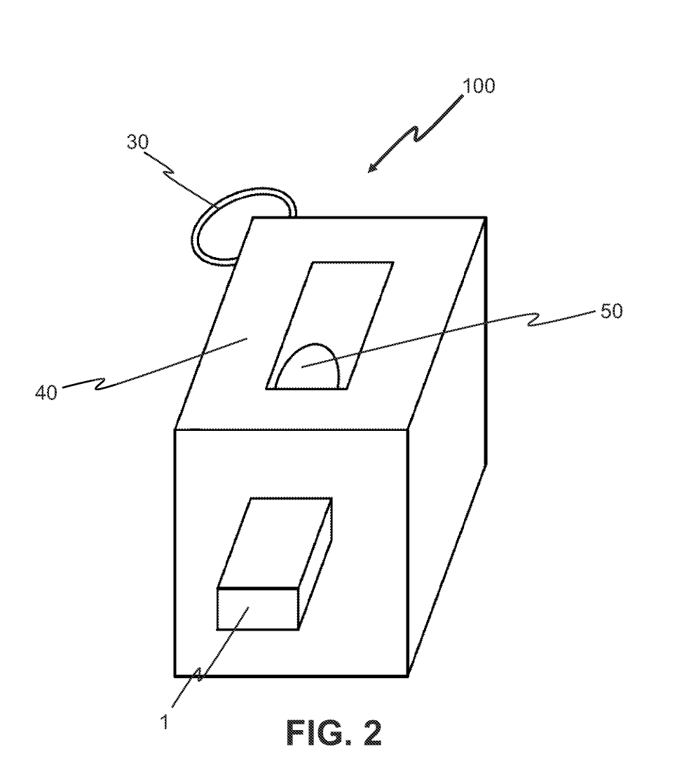

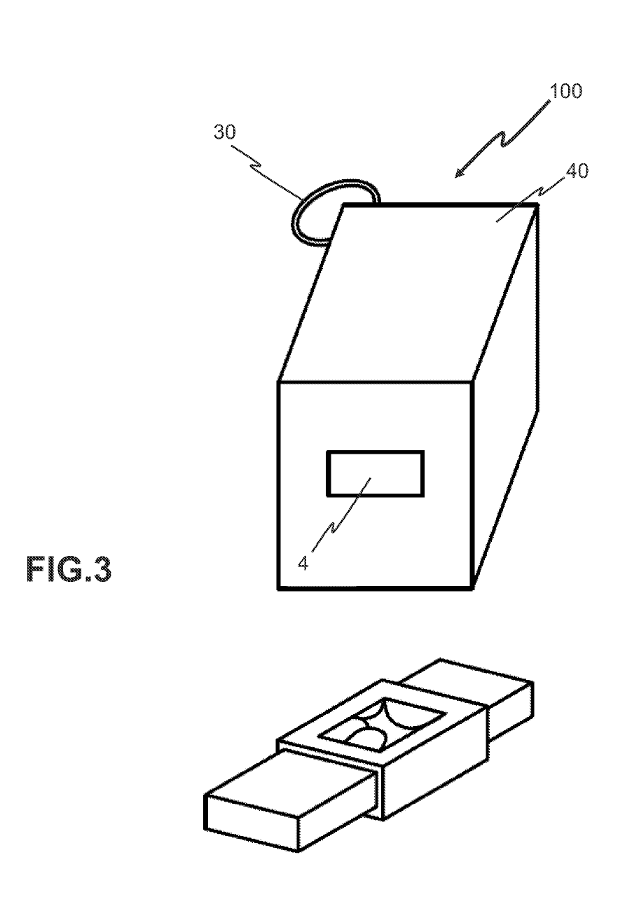

The “social version” has two types, a “male version” and a “female version”. FIG. 2 discloses a device of male version 100 which has a retractable USB plug 1 for battery charging, information downloading from a PC, and data exchanges on one side of the cube. FIG. 3 discloses a device of female version 100 which has a USB receptacle 4 on one side of the cube for data exchange. When either of a USB plug or USB receptacle is properly interfaced to an appropriate gender connector on a companion device 100, a person's information would be automatically transferred to the companion device 100. The male version device may also exchange data via a PC, PDA, and/or smart phone, etc. The “female version” of the device further comprises an “USB adapter” 20 so it may be directly plugged into a personal PC for battery charging or information downloading or data exchange via a PC, PDA, or smart phone.

The device 100 may further comprise a ring 30 on a corner of the cube which can be used to hold keys or attach to a key chain or a purse fob.

Although it is unlikely to be damaged if unprotected, both of the USB plug 1 and USB receptacle 4 may be protected by a removable cap. The USB plug 1 may be retracted into the enclosure 40 and slide or flip-out to work by any appropriate means 50. The enclosure 40 may be made of plastic, metal, rubber and/or any combinations thereof. The enclosure 40 may be manufactured from injection or structural-foam molded from polystyrene or polycarbonate. The USB plugs 21 on USB adapter 20 for the female version may also be retractable.

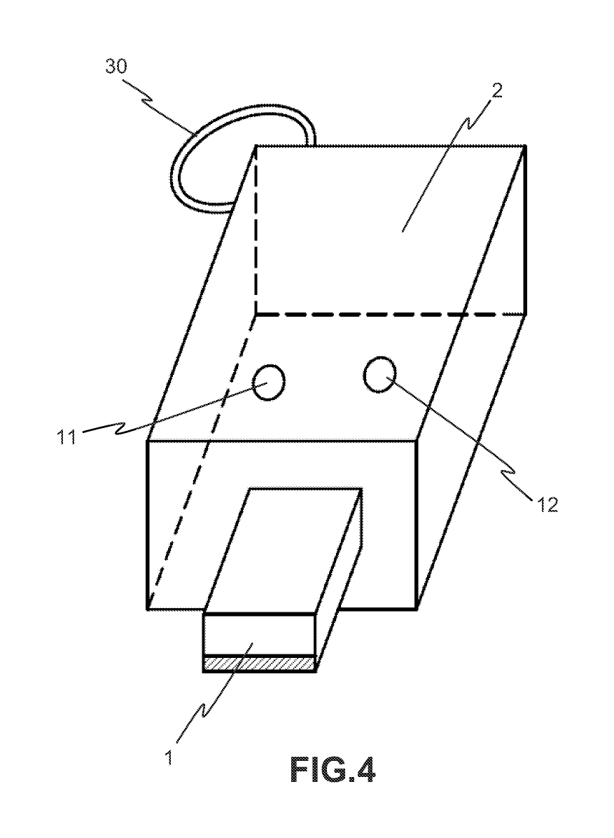

The data exchange port may be an infrared port or a radio frequency (RF) antenna for wireless data exchange 11, 12 on any remaining sides as shown in FIG. 4.

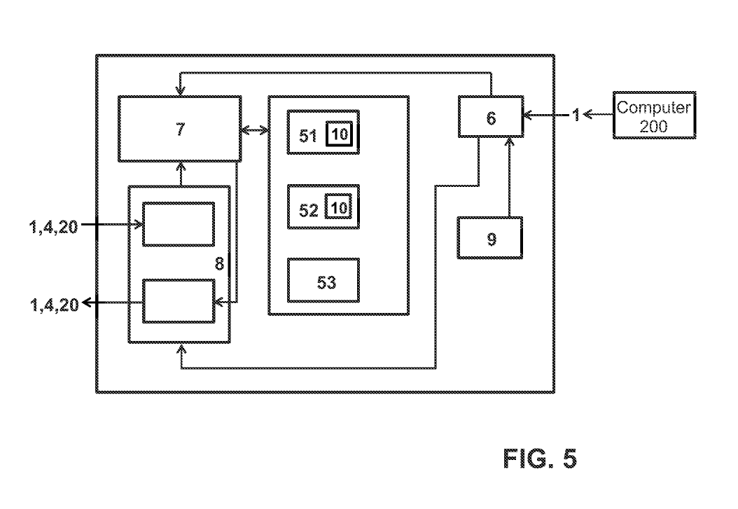

Referring to FIG. 5, there is disclosed a block diagram of the internal components according to one embodiment of the device 100. The device 100 comprises an internal data controller 7 and data transceiver circuitry 8 for data transfer purposes. The data controller 7 and transceiver circuitry 8 are coupled to an internal memory partition feature 5 to allow the owner to store personal contact data, business contact data, and other data in separate memory storage locations 51, 52, 53. As with other flash-memory storage products, the data content stored in the device 100 would be non-volatile. The device 100 further comprises an internal rechargeable battery 6 which is only used to power the internal data controller 7 and data transceiver circuitry 8 for data transfer purposes. The rechargeable battery 6 can be recharged by the power supply of the computer 200 via the USB plug 1 when the device 100 is connected to a computer 200. The device 100 also has automatic power-on/power-off features 9 which would eliminate the need for manual power control buttons and prevent dead-battery situations with the device. Each device 100 could come with its own generic vCard 10 format file stored in a separate “send” partition of the device's memory. After the purchase of this device, a person could insert its retractable USB connector 1 into a suitable USB-enable device (i.e. PC, PDA, smart phone, etc.) and use that device's keypad or keyboard to create a personalized vCard 10 from that generic vCard 10 format file. The device 100 of the present invention when properly interfaced to an appropriate connector on a companion device, the owner's personal information would be automatically transferred to the companion unit. The device also comprises security and firewall protection to prevent data virus infection or unintentional data access.

The method of or arrangement of wiring or connecting the above electronic components and mounting them will be well known to those with ordinary skill in the art.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A small portable personal data interchange (PDI) device for communicating owner's personal information to a companion PDI device comprising:
an internal data controller and data transceiver circuitry to provide data interchange functions;
an internal memory having multiple partitions to allow the owner to store personal contact data, business contact data, and other data in separate memory storage locations;
a generic vCard format files stored in the separate partition of the memory;
an internal rechargeable battery used to power the internal data controller and data transceiver circuitry for data transfer purpose;
security and firewall protection to prevent data virus infection or unintentional data access;
a USB plug having a USB flash memory card interface for charging, initially downloading the owner's personal information, and personal information exchange; and
an enclosure to enclose the internal data controller, data transceiver circuitry, rechargeable battery, and providing location for the USB port connector;
wherein the device is configured to accept the owner's personal information in a standard electronic business card (vCard) format, the device is small and simple such that it can be attached to a key chain or purse fob for timely data exchange of digital personal or business information or serve as a standard thumb drive for general file transfers.

2. The small PDI device of claim 1 having physical appearance of a cube of about one inch for each dimension and/or any geometric fob design.

3. The small PDI device of claim 1, the device is configured to accept image or video files, audio files, text or data files and can serve as a standard thumb drive for general file transfers with data-to-go convenience.

4. The small PDI device of claim 1 wherein the data content is stored in non-volatile memory.

5. The small PDI device of claim 1 further comprising automatic power-on/power-off features that eliminate the need for manual power control buttons and prevent dead battery situations.

6. The small PDI device of claim 1, the device is manufactured using surface-mount printed circuit card assembly techniques with automated soldering lines and pick and place component handling equipment.

7. The small PDI device of claim 1, wherein the enclosure being manufactured from injection or structural-foam molded from polystyrene or polycarbonate.

8. The small PDI device of claim 1 further comprising means for retracting the USB plug.

9. The small PDI device of claim 1 further comprising a ring for attaching to a key chain or a purse or allowing keys or purse to be attached.

10. The small PDI device of claim 1 further comprising a USB receptacle for data/information exchange with appropriate gender connector on another device.

11. A small portable personal data interchange (PDI) device for communicating owner's personal information to another party comprising:
an internal data controller and data transceiver circuitry to provide data interchange functions;
an internal memory partition feature to allow the owner to store personal contact data, business contact data, and other data in separate memory storage locations;
a rechargeable battery;
a generic vCard format files stored in a separate partition of the memory;
security and firewall protection to prevent data virus infection or unintentional data access;
a USB receptacle for personal information exchange; and
an enclosure to enclose the internal data controller, data transceiver circuitry, rechargeable battery, and providing location for the USB receptacle;
wherein the device is configured to accept the owner's personal information in a standard electronic business card (vCard) format, the device is small and simple such that it can be attached to a key chain or purse fob for timely data exchange of digital personal or business information or serve as a standard thumb drive for general file transfers.

12. The small PDI device of claim 11, further comprising an infrared data port for wireless personal data/information exchange in “vCard” format exchange.

13. The small PDI device of claim 11 further comprising a radio frequency antenna for wireless personal data/information exchange in “vCard” format exchange.

14. The small PDI device of claim 11, the device further comprising an USB adapter for the PDI device that has a USB receptacle for plugging into a PC, PDA, or smart phone.

15. The small PDI device of claim 11 having physical appearance of a plastic cube of about one inch for each dimension and/or another geometric fob design.

16. The small PDI device of claim 11, the device is configured to accept image or video files, audio files, text or data files, and serve as a standard thumb drive for general file transfers.

17. The small PDI device of claim 11 further comprising automatic power-on/power-off features that eliminate the need for manual power control buttons and prevent dead battery situations.

18. The small PDI device of claim 11, the device is manufactured using surface-mount printed circuit card assembly techniques with automated soldering lines and pick and place component handling equipment.

19. The small PDI device of claim 11 further comprising a ring for attaching to a key chain or a purse or allowing keys or purse to be attached.

20. A small portable personal data interchange (PDI) device for communicating owner's personal information to a companion PDI device comprising:
an internal data controller and data transceiver circuitry to provide data interchange functions;
an internal memory having multiple partitions to allow the owner to store personal contact data, business contact data, and other data in separate memory storage locations;
a generic vCard format files stored in the separate partition of the memory;
an internal rechargeable battery used to power the internal data controller and data transceiver circuitry for data transfer purpose;
security and firewall protection to prevent data virus infection or unintentional data access;
a USB plug having a USB flash memory card interface for charging, initially downloading the owner's personal information, and personal information exchange with an appropriate gender connector on another device;
a USB receptacle for data exchange with an appropriate gender connector on another device; and
an enclosure to enclose the internal data controller, data transceiver circuitry, rechargeable battery, and providing location for the USB plug and receptacle;
wherein the device is configured to accept the owner's personal information in a standard electronic business card (vCard) format, the device is small and simple such that it can be attached to a key chain or purse fob for timely data exchange of digital personal or business information or serve as a standard thumb drive for general file transfers.
